(19) United States
(12) Patent Application Publication
(10) Pub. No.: US 2023/0367867 A1
(43) Pub. Date: Nov. 16, 2023

(54) ROUTER

(71) Applicants: S TMicroelectronics S. r. I., Agrate Brianza(MB) (IT); Proton World International N.V., Diegem (BE)

(72) Inventors: Olivier Van Nieuwenhuyze, Wezembeek-Oppem (BE); Amedeo Veneroso, Caserta (IT)

(21) Appl. No.: 18/314,677

(22) Filed: May 9, 2023

(30) Foreign Application Priority Data
May 13, 2022 (FR) 2204563

(51) Int. Cl. G06F 21/44; G06F 21/71

(52) U.S. Cl. CPC G06F 21/44; G06F 21/71

(57) ABSTRACT

In an embodiment an electronic device includes at least a first electronic module, a secure element, a router configured to transmit first data between the first module and a second module and a third-party module different from the first module and the second module, wherein the electronic device is configured to verify, via an authentication method, whether the third-party module is authorized when it requests access to the first data.

### CROSS-REFERENCE TO RELATED APPLICATIONS

This application claims the benefit of French Application No. 2204563, filed on May 13, 2022, which application is hereby incorporated herein by reference.

### TECHNICAL FIELD

The present disclosure generally concerns electronic systems and devices, and more particularly the protection of data of a user using such an electronic system or device.

### BACKGROUND

Complex electronic devices, such as cell phones, tablet computers, computers, etc. integrate, over time, more and more functionalities and enable to implement digital services in order to integrate at best in everyday life. To implement these functionalities, these devices may integrate electronic components specific to these functionalities and adapted to exchanging data with one another. These data may comprise private or critical information.

Integrate new electronical component, for example to improve security or to add new features, implies increasing the power consumption and the surface occupied by the dies used in those electronical devices.

It would be desirable to be able to at least partly improve certain aspects of the access and/or the protection of data exchanged within a same electronic system or device, and to minimize the dimensions of these electronical devices.

### SUMMARY

Embodiments provide electronic systems or devices where the internal data exchange is better protected, and respond to certain standards.

Embodiments provide electronic systems or devices wherein the features of some of their electronical components are integrated to their main die in order to minimize the surface occupied by the components used in those electronical systems or devices.

Further embodiments provide secured communications between different parts of the same die linked to different features, for example, for debug purposes.

Other embodiments provide electronic systems or devices comprising a router where the internal data exchange is better protected.

Yet other embodiments provide electronic systems or devices comprising a secure element where the internal data exchange is better protected.

An embodiment overcomes all or part of the disadvantages of known electronic systems or devices.

One embodiment provides a method of communication, to a third-party module of a first electronical device, of first data exchanged between a first module of the first electronic device and a second module, the third-party module between different from the first module and the second module, the first device comprising at least a secure element and a router transmitting the first data from the first module to the second module, the router being adapted to being set to a secure mode wherein, when the third-party module is asking to get access to the first data, an authentication method is implemented to verify whether the third-party module is authorized or not to get access to the first data.

Another embodiment provides an electronic device comprising:
at least a first electronic module;
a secure element;
a router transmitting first data between the first module and a second module; and
a third-party module different from the first module and the second module, router being adapted to being set to a secure mode wherein, when the third-party module is asking to get access to the first data, an authentication method is implemented to verify whether the third-party module is authorized or not to get access to the first data.

According to an embodiment, during the implementation of the authentication method, the first data are stored in the secure element or in the router.

According to an embodiment, during their storage, the first data are at least partially visible by the third-party module.

According to an embodiment, the authentication method is implemented by the router.

According to an embodiment, the authentication method is implemented by the secure element.

According to an embodiment, the authentication method enables to authenticate, besides the third-party module, the first module, the second module, or the user of the first device.

According to an embodiment, the authentication method is implemented via an external server.

According to an embodiment, the authentication method comprises the execution of secondary rules.

According to an embodiment, the router is adapted to requesting the authorization to be in the secure mode.

According to an embodiment, the router is adapted to leaving the secure mode on reception of a specific instruction.

According to an embodiment, the specific instruction originates from the secure element.

According to an embodiment, the router comprises a series of rules concerning the security policy of the communications of the first device.

According to an embodiment, the secure element transmits said series of rules to said router.

According to an embodiment, the second module forms part of the first electronic device.

According to an embodiment, the second module forms part of a second electronic device, different form the first electronic device.

According to an embodiment, router in integrated to a die executing the first module and/or the third-party module.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 shows schematically an example of an electronic device capable of implementing the embodiments of FIGS. 5-8;

FIG. 2 shows a more detailed example of the device of FIG. 1;

FIG. 3 shows another more detailed example of the device of FIG. 1;

FIG. 4 shows yet another more detailed example of the device of FIG. 1;

FIG. 5 shows a block diagram illustrating an implementation mode of a method for internal communication of the device of FIG. 1;

FIG. 6 shows a block diagram illustrating an implementation mode of a method of internal communication of the device of FIG. 1;

FIG. 7 shows a block diagram illustrating another implementation mode of a method for internal communication of the device of FIG. 1; and

FIG. 8 shows a block diagram illustrating yet another implementation mode of a method for internal communication of the device of FIG. 1.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the different internal communication protocols used by the different modules of an electronic device are not detailed herein, the described embodiments being adapted to being implemented with usual communication protocols.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless otherwise specified, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

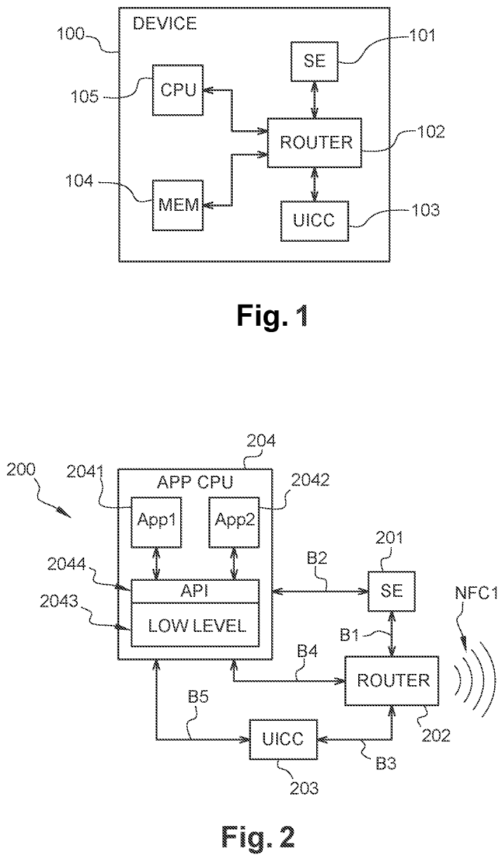

FIG. 1 very schematically shows in the form of blocks an embodiment of an electronic device wo (DEVICE) to which the communication methods described in relation with FIGS. 5 to 8 may apply.

Device wo comprises, at least:
a secure element 101 (SE);
a router 102 (ROUTER); and
at least two other electronic modules.

Secure element 101 is an electronic device adapted to processing critical and/or secret data, and which is considered as reliable. Secure element 101 comprises, itself, for example, a processor, one or a plurality of memories, ciphered data processing modules, such as, for example, a data ciphering module and/or a data deciphering module. Secure element 101 is adapted to communicating with the other electronic modules of device wo via router 102. According to a variant, the secure element 101 can have a direct communication line with one or more other components/modules of device 100. According to an example, this communication line can be executed by binding commands, by a communication bus, and/or a shared memory.

Router 102 is an electronic device adapted to managing all or part of the internal communications of device 100, preferably all internal communications, but which may further manage at least part of the external communications of device 100. Here call internal communications of device wo the communications, that is, the data and instruction exchanges, between electronic modules which are internal to device 100. The external communications of device 100 are, in this case, the communications, that is, the data and or instruction exchanges, carried out with one or more components of the electronical device and one or a plurality of devices external to device 100. Router 102 can be adapted to, further, manage communications internal to device 100 wherein data can be destined to external communications. According to an example, router 102 can be adapted to execute data conversion, as for example data adaptations for data adapted to a first protocol to data adapted to a second protocol different from the first protocol.

During an internal communication, router 102 has the function of receiving all the data and/or instructions transmitted by a first electronic module of electronical device 100, and then of transmitting them to a second electronic module of electronical device 100. For this purpose, router 102 for example uses:
information contained in the data and/or instructions to be transmitted;
or, for example, emission relative and/or reception relative data provided by the first module, and, if so, the second module; and/or
data contained in an internal correspondence table.

During an external communication, router 102 has the function of receiving all the data or instructions transmitted by an external device, and of addressing them to one or a plurality of internal modules of device 100, or, oppositely, receiving all the data or instructions transmitted by an internal device of device 100, and of addressing them to a device external to device 100. For this purpose, router 102 uses, for example, information contained in the data and/or instructions to be transmitted or, for example, data provided by the external electronic device.

Moreover, and according to an embodiment, router 102 is adapted to allow some internal module of device 100 to get access to all or part of data exchanged during an internal or external communication of which it is not a part of. In other words, router 102 can allow, to an internal module of device 100, to have access to data of which it is not the first recipient. In this case, it is said the module is registering, “logging” (communication log). In the following description, it is called a third-party module, an internal module of device 100 wanting to have access to all or part of data of a communication of which it is not a part of in the first instance. In other words, a third-party module to a communication is a module different from the module initiating the communication and different from the module receiving the communication.

According to an embodiment, when a third-party module is looking for getting access to communication data, router 102, when in a secured mode, can apply a specific treatment to some communications. More particularly, router 102 can store, or make another component/module store, all or part of data, and ask to the third-party module to get authentication before allowing it, or not, to get access to all or part of data. Communication can be, equally, an internal communication or an external communication. The authentication of the third-party module may be implemented by router 102 itself, or according to an alternative embodiment, by secure element 101. Similarly, communication data can be stored by router 102 or by secure element 101 before the authentication of third-party module being made. According to an embodiment, the secured mode can be activated by an authentication process. This secure element is described in further detail in relation with FIGS. 5 to 8.

It is called in this description, a module un group of circuits and/or components linked to one or a plurality of features of the electronical device. Said one or a plurality of other electronic modules of the device are, as an example, a universal integrated circuit card (UICC) 103, one or a plurality of memories 104 (MEM), and a processor or microprocessor 105 (CPU). These modules are conventional electronic modules of an electronic device and enable it to implement one or a plurality of functionalities. Device boo is, for example, a wireless phone, a smartphone, a connected object, a tablet, etc. According to an alternative embodiment, it can designate by the expression “module” a software entity executed by the electronical device.

According to an embodiment, router 102 is a module independent from other modules of electronic device 100, meaning that router 102 is not bundled with another module of device 100. In other words, router 102 can physically be isolated from other modules, for example, by being executed by a single die, and/or, by being isolated by means of software, for example, by being protected from others software executed by device 100.

According to another embodiment, router 102 can be bundled with one or several modules of device 100. In other words, router 102 can be executed physically and or executed by means of software in a bundle manner with other modules. According to a first example, router 102 can be executed by the same die as one or several other modules of electronic device 100, or can be integrated or embedded to a die executing one or several other modules of electronic device 100. According to a second example, router 102 can be executed by the same operating system as one of several other modules of device 100.

FIGS. 2, 3, and 4 illustrate more detailed examples of electronic devices of the type of device 100. FIGS. 5 to 8 illustrate implementation modes of secure communication methods capable of being implemented by device 100 or one of the devices described in relation with FIG. 2, 3 or 4.

FIG. 2 very schematically shows in the form of blocks an example of embodiment of an electronic device 200 of the type of the electronic device 100 described in relation with FIG. 1.

Device 200 comprises:
a secure element 201 (SE);
a router 202 (ROUTEUR); and
at least two electronic modules among which a universal integrated circuit card 203 (UICC), and a processor 204 (APP CPU).

Secure element 201 is of the same type as the secure element 101 described in relation with FIG. 1. According to an example, secure element 201 is adapted to communicating with router 202 via a data bus B1 adapted to SWP (Single Wire Protocol) communications or via a memory adapted to IPC (Inter-Process Call) communications. According to an example, secure element 201 is adapted to directly communicating with processor 204 via a data bus B2 adapted to I2C (Inter-Integrated Circuit) or SPI (Serial Peripheral Interface) communications.

Router 202 is of the same type as the router 102 described in relation with FIG. 1. Router 202 is particularly adapted to managing part of the communications internal to device 200 and to managing the near-field communications (NFC) NFC1 of device 300. For this purpose, router 202 is adapted to communicating with secure element 201 via data bus B1, with universal integrated circuit card 203 via a data bus B3, and with processor 204 via a data bus B4. Data bus B3 is adapted to SWP-type communications. Data bus B4 may be of same type as bus B2.

Universal integrated circuit card 203 is, for example, a SIM (subscriber identity/identification module) card that may be considered as a secure element. According to an example, card 203 is adapted to directly communicating with processor 204 via a data bus B5 adapted to communications of ISO7816 type. The universal integrated circuit card 203 can a removable physical card or an integrated card.

Processor 204 is a processor adapted to implementing one or a plurality of applications, for example, two applications 2041 (App1) and 2042 (App2) in the example illustrated in FIG. 2. For this purpose, processor 204 is adapted to implementing a plurality of software programs used as an interface between applications 2041 and 2042 and the other modules of device 300. This interface software for example comprises low-level software 2043 (LOW LEVEL) and conversion software 2044 (API). The interface software is adapted to translating the instructions sent by the applications into instructions understandable by the other modules of device 300. According to an example, conversion software 2044 is software enabling to translate an instruction originating from an application into a plurality of instructions, each intended for a module of device 300. According to an example, low-level software 2043 is software adapted to converting instructions intended for a module of device 300 into an instruction understandable by said module. Other architectures are here possible, and the example described herein is not limiting. Data bus B2, B4, and B5 are adapted to communicating with the interface software, for example, the low-level software 2043, of processor 204.

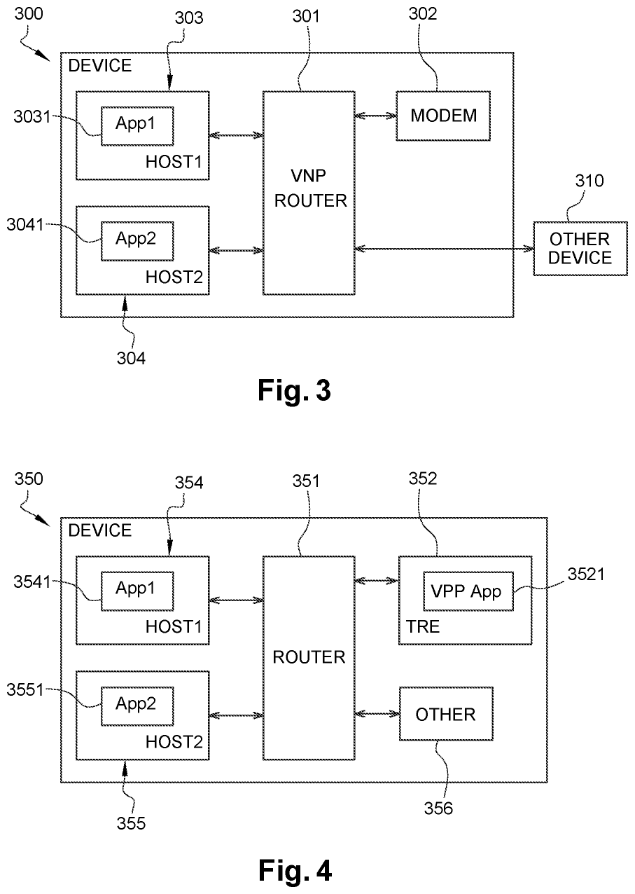

FIG. 3 very schematically shows in the form of blocks an embodiment of an electronic device 300 (DEVICE) of the type of the electronic device 100 described in relation with FIG. 1.

Device 300 comprises:
a router 301 (VNP ROUTER);
a modem 302 (MODEM);
first host software 303 (HOST 1) implementing at least one application 3031 (App1); and

second host software 304 (HOST 2) implementing at least one application 3032 (App2).

Router 301 is router which manages all the internal communications of device 300, and also at least part of the external communications of device 300. According to an example router 301 allows a wired or wireless communication with an external device 310 (OTHER DEVICE).

Modem 302 is for example a module allowing the connection of device 300 to a communication network, for example, the telephone network or the Internet. Modem 302 comprises a secure element, for example, a universal integrated circuit card, enabling it to obtain authorizations of connection to said communication network.

The first and second host software 303 and 304 are for example processors or portions of processors dedicated to an application or one or a plurality of groups of applications. In FIG. 3, each host software 303, 304 is dedicated to an application.

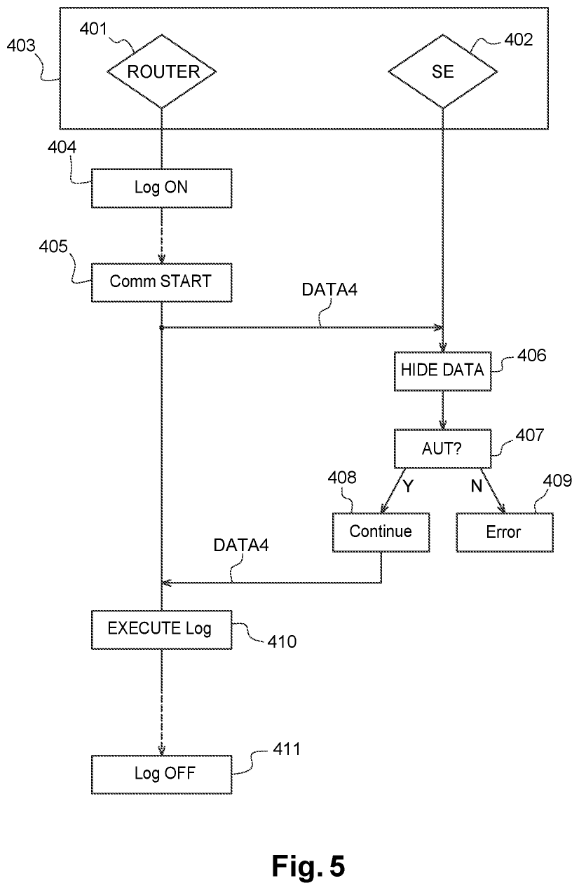

FIG. 4 very schematically shows in the form of blocks an embodiment of an electronic device 350 (DEVICE) of the type of the electronic device 100 described in relation with FIG. 1.

Device 350 comprises:
a router 351 (ROUTER);
a tamper resistant element 352 (TRE) executing at least an application 3521 (VPP APP);
first host software 353 (HOST 1) implementing at least one application 3531 (App1);
second host software 354 (HOST 2) implementing at least one application 3032 (App2); and
one or more other electronical components 356 (OTHER).

Router 351 is router which manages all the internal communications of device 300 from or to the tamper resistant element 352. Router 351 can, further, manage communications from or to the others components 356.

Tamper resistant element 352 is a secured element adapted to execute applications, as application 3521. Tamper resistant element 352 can be formed on a die different from the one of the router, or can be integrated with the router 351. In the case where tamper resistant element in integrated to router 351, communications between these two elements can be executed by on or more buses and/or one or more internal memories of router 351. According to an example, tamper resistant element 352 can be integrated to another component of device 350, as, for example, a processor, in this case, all communications from or to the tamper resistant element will use router 351 to be executed.

Tamper resistant element 352 comprises for example its own memories (one or more), and application 3521 can be stored in one of these memories. Tamper resistant element 352 is also adapted to execute several applications of type of application 3521 (VPP App). Several execution are possible, one of its can be based on the storage of data of applications in an internal memory or in external memories to the tamper resistant element 352. In the case of an external storage, data stored in one or several external memories can be protected by the tamper resistant element, for example by a cyphering algorithm. Another execution can comprise the use of a storage in an internal memory and a storage in an external memory.

Frist and second host software 354 and 355, and applications 3541 and 3551 are of the type of host software and applications described in relation to FIG. 3.

FIG. 5 is a block diagram illustrating an implementation mode of a method of secure communication, wherein a third-party module is looking for access to communication data. The method of communication implements a router 401 (ROUTER) and a secure element 402 (SE) of a same electronic device 403. Device 403 is of the type of the device 100 described in relation with FIG. 1, and thus router 401 and secure element 402 are of the type of router 102 and of secure element 101.

At a step 404 (block “Log ON”), router 401 triggers the secure mode wherein an authentication is asked to a third-party module wanting to get access to communication data. According to an example, the secure mode is activated after having received an instruction originating from the secure element or after a specific event, for example, the switching of the full device to a specific operating mode, for example, a test mode.

According to an alternative embodiment, router 401 may ask for an authorization to be in the secure mode. This authorization may originate from secure element 401, from the user of device 403, or from an external server. According to another example, the authorization can be provided by an authentication process using the recognition of the user of electronical device 403, this authentication process being able for example to ask for a password or a biometric recognition. The authorization obtained by router 401 can, according to an example, be verified by router 401 or by secure element 402.

At a step 405 (block “Comm START”), successive to step 404, a communication starts. The communication may be a communication internal to device 403 or an external communication between device 403 and another electronic device. In practice, router 401 starts receiving data DATA4 from a communication between a first module and a second module. First module is part of electronic device 403, and second module can be an internal module of electronical device 403 or a device that is external to device 403. According to an example, communication can be a communication between two modules of device 403, a communication between a module of device 403 and an external device, or even a communication between the secure element 402 and another module of device 403 or an external device.

Moreover, at step 405, a third-party module, meaning a module that is different from the first and the second module, ask for getting access to all or part of data DATA4 of the communication.

Router 401 plays his role and transmits data DAT4 from the first module to the second module. However, since router 401 is in a secure mode and since a third-party module is asking access to data DATA4, data DATA4 are, moreover, copied and transferred to secure element 402.

At a step 406 (block “HIDE DATA”), secure element 402 receives data DATA4 and stores them in secure fashion. Data DATA4 are not rendered accessible to the third-party module by router 401. According to an alternative embodiment, data DATA4 are stored in secure fashion by router 401 itself. According to an example, if the storage capacity of secure element 402, or of router 401, if present, is saturated, router 401 may be adapted to detecting it and to transmitting an error signal.

At a step 407 (block “AUT?”), the secure element starts an authentication method of the third-party module to verify whether data DATA4 can be transmitted to it by the element stocking it, meaning router 401 or secure element 402.

According to a first example, the authentication method is intended to directly authenticate the third-party module, but also the first module and/or the second module.

According to a second example, the authentication method is intended to directly authenticate the third-party module by authenticating the user of device 403, for example, by requesting a PIN code.

According to a third example, the authentication method is intended to authenticate is executed via a service using an external server that might want access to data DATA4.

According to a fourth example, authentication process comprises the execution of several secondary rules. A secondary rule can be the execution of an authentication process asked by a module of device 403 or by a software or an application executed by device 403.

Further, and according to a variant, data DATA4 may be visible or partially visible by the third-party module during the implementation of the authentication method. According to a first example, data DATA4 are totally visible by the third-party module which is being authenticated. According to a second example, only part of data DATA4 is visible by the third-party module, for example, the headers of data DATA4. According to a third example, only the shape, or the configuration, of data DATA4 are visible by the third-party module, for example to recognize whether data DATA4 are data concerning a critical communication, meaning a communication of which data are critical and need to be protected, such as a bank transaction or the identification of a user for the use of a SIM card (subscriber identity/identification module). According to an example, if a user submits its PIN code to start the use of a SIM card, information relative to this PIN code are anonymized.

If the result of the authentication is correct (output Y of block “AUT?”), the next step is a step 408 (block “Continue”), otherwise (output N of block “AUT?”), the next step is a step 409 (block “Error”).

At step 408, the third-party module is authorized to get access to all or part of data DATA4. For this purpose, data DATA4 are sent back to the router. According to a variant, if data DATA4 are stored by router 401 then, at this step, data DATA4 are made accessible to the third-party module.

At step 409, the communication is not authorized by secure element 402. In this case, data DATA4 can be deleted so the third-party module never has access to it. According to a variant, an error counter can be set up in order to let several chances to the third-party module, or to the user, having to authenticate itself. According to an example, the counter can count the trials, and if the number of trials exceed a limit value then the possibility of authenticated itself is deactivated for predeterminate period. According to another example, if the value of the counter reaches a limit value, then data DATA4 are erased, but as long as the value of the counter is inferior to the limit value, data DATA4 are conserved.

At a step 410 (block “EXECUTE Log”), successive to step 408, router 401 transmits data DATA4 to the third-party module. According to an example, the authentication performed by secure element 402 gives the authorization to make all or part of data DATA accessible. According to another example, router 401 may periodically request, during the implementation of the communication, for an authentication to be performed.

At a step 411 (block “Log OFF”), successive to step 410, router 401 leaves its secure mode. According to an example, router 401 may leave this mode after having received an instruction originating from the secure element or after a specific event, for example, the switching of device 403 to another specific operating mode.

An advantage of this embodiment is that it enables to add an additional protection level to the internal and external communications of an electronic device.

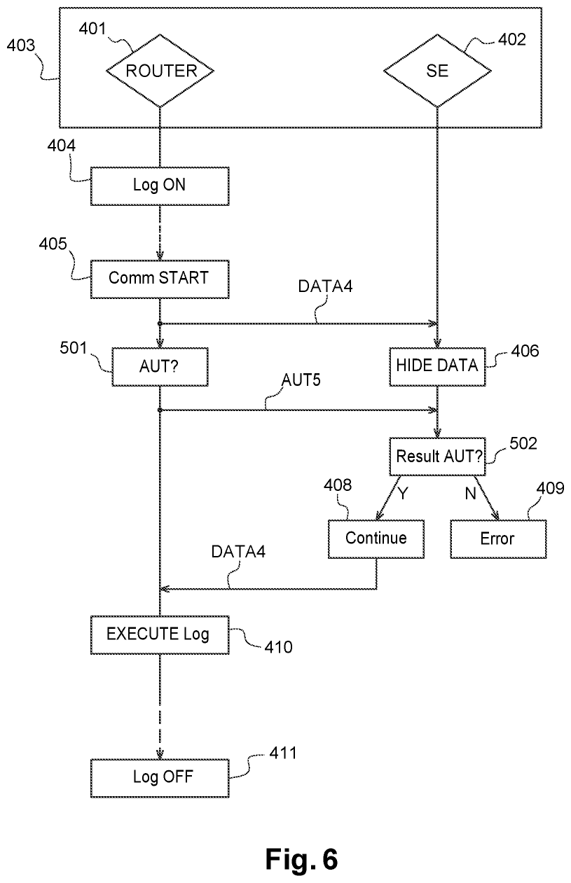

FIG. 6 is a block diagram illustrating another implementation mode of a secure communication method implementing a router 401 (ROUTER) and a secure element 402 (SE) of a same electronic device 403 of FIG. 5.

The implementation of the secure communication method described in relation with FIG. 5 has elements in common with the secure communication method described in relation with FIG. 4. In particular, in the method of FIG. 6, the authentication of third-party module is implemented by router 401, and not by secure element 402.

Thus, the method of FIG. 6 comprises steps common with the method of FIG. 4, these common steps are not described again herein. These common steps are:
step 404 (block “Log ON”);
step 405 (block “Comm Start”);
step 406 (block “HIDE DATA”);
step 408 (block “Continue”);
step 409 (block “Error”);
step 410 (block “EXECUTE Log”); and
step 411 (block “Log Off”).

As in FIG. 5, the method starts with step 404, which is followed by step 405.

Step 405 is followed by a step 501 (block “AUT?”) during which router 401 starts an authentication method to authenticate the third-party module. According to a first example, the authentication method is intended to directly authenticate the third-party module, but also the first module and/or the second module. According to a second example, the authentication method is intended to directly authenticate the user of device 403, for example, by requesting a PIN code. According to a third example, the authentication method is intended to authenticate the third-party module via a service using an external server.

Information AUT5 concerning the success or not of the authentication method is sent to secure element 402, if the latter is effectively the one storing data DATA4.

At a step 502 (block “Result Aut?”), secure element 402 receives information AUT5 and deduces therefrom whether the authentication has succeeded or not. If information AUT5 indicates that the authentication is correct (output Y of block “Result Aut?”), the next step is a step 408, otherwise (output N of block “Result Aut?”), the next step is a step 409 (block “Error”).

Step 408 is then followed by step 410, and then by step 411.

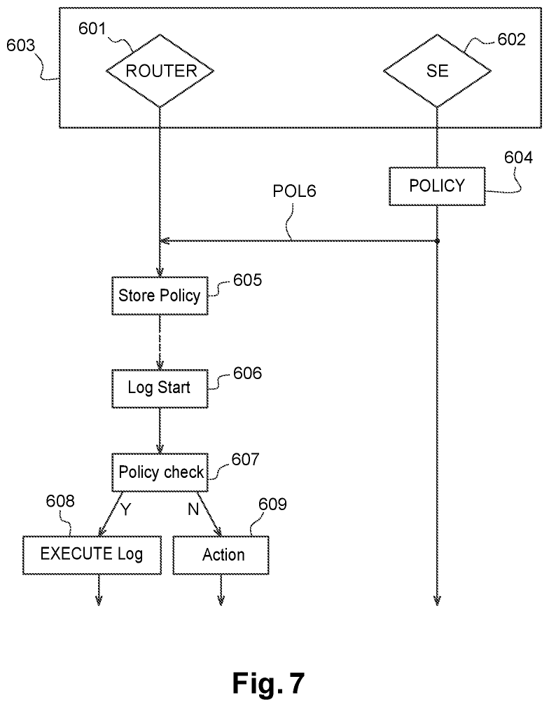

FIG. 7 is a block diagram illustrating another implementation mode of a method of secure communication, wherein a third-party module is looking to get access to data of a communication. The communication method implements a router 601 (ROUTER) and a secure element 602 (SE) of a same electronic device 603 of FIG. 7. Device 603 is of the type of the device 100 described in relation with FIG. 1, and thus router 601 and second element 602 are, respectively, of the type of router 102 and of secure element 101.

At a step 604 (block “POLICY”), secure element 602 has at its disposal a series of rules POL6 concerning a policy of protection of internal communications, and optionally of external communications, of device 101. This series of rules POL6 is intended to be implemented by router 601 when a third-party module ask for getting access to data of a communication.

It is called rule, an instruction that the router need to execute in a specific situation.

The series of rules POL6 can comprise different types of rules. According to a first example, a rule of the series of rules POL6 can forbid to a specific third-party module, or to any third-party module, the access to data of a specific communication, for example a communication of a certain type. According to a second example, another rule of the series of rules POL6 can authorize the transmission of all or part of data of a specific communication to a third-party module. According to a third example, another rule of the series of rules POL6 can force a third-party module to authenticate itself in several manners in order to get access to all or part of data of a communication. Others rules are described hereafter, and still others rules can be envisaged by the person skilled in the art without demonstrate an inventive step.

Secure element 601 may obtain the series of rules POL6 with several manners. According to a first example, secure element 601 may create the series of rules POL6 from instructions supplied by the constructor of device 603, by the user of device 603, via an external server (that may authorize the communication directly or by another authentication system), and/or by software and applications executed by device 603. In this case, secure element 602 may update the series of rules for each new received instruction. According to a second example, the series of rules POL6 is stored in secure element 601 without for the latter to be able to modify it.

According to an embodiment, when applications are executed by device 603 are the source of the series of rules, different rules can be applied depending of which application is started or is executed. These rules can be completed by rules provided by the operating system of device 603 and/or by rules provided by a protection or security software of device 603. A protection or security software can, for example, provide rules preventing the execution of rules of a specific application that he believes to be not reliable, or forcing hiding some sensible data.

According to another embodiment, rules POL6 can be protected by secure element 602 in order to guarantee their integrity. To this end, secure element 602 can apply a signature process to rules POL6.

At a step 605 (block “Store Policy”), successive to step 604, router 601 receives the series of rules POL6 from secure element 602 and stores it. Router 601 having this series of rules in memory, it may implement it at the time when it receives data for an internal or external communication of device 603.

At a step 606 (block “Comm Start”), successive to step 6o5, a communication starts. The communication may be a communication internal to device 603 or an external communication between device 603 and another electronic device. In practice, router 601 starts receiving data from a first module to transmit them to a second module. According to an example, the first module is an internal module of the device 603, and the second device is equally an internal module of the device or an external device to the electronical device 603.

Further, at step 606, a third-party module is asking for access to data exchanged during the communication.

At a step 607 (block “Policy Check”), router 601 consults the series of rules POL6 in order to know if a rule has to be executed. If no rule has to be executed (output Y of block “Policy Check”), the next step is a step 608 (block “EXECUTE Comm”), otherwise (output N of block “Policy check”) the next step is a step 609 (block “Action”).

At step 608, successive to step 607, router 601 transmits the data to the third-party module without for any other action to be implemented.

At step 609, successive to step 607, a rule of the series of rule POL6 corresponds to the situation in which in the communication. Router 601 then executes the rule.

According to an example, a rule may impose for the data transfer to the third-party module of a communication originating from a specific module of device 603 or from a device external to device 603 to be preceded by an authentication process, for example, carried out by router 601 or by secure element 602. According to another example, a rule may forbid the transmission to a third-party module of all data of a communication from a specific module of device 603 or from a device external to device 603. According to another example, a rule may impose for all the data of a certain type, for example, data all having a specific format or header, to be ciphered.

In the case where certain of rules are provided by applications executed by device 603, rules provided by these applications can concern the type of authentication process used to allow or not the communication.

Moreover, if rules followed for a communication are provided by a first and second applications that are being executed, then the rules provided by both applications can be used in parallel. According to a practical example, if a first application A requires the presentation of a password to authorize the transmission of data DATA-A being part of data DATA of a communication, and if a first application B requires an authentication by password and via an external server to authorize the transmission of data DATA-B being part of data DATA, an user furnishing only the password will not see the transmission of data DATA-A and not the transmission of data DATA-B. If device 603 is equipped with a screen, the user may, for example, know which rule has been executed and which rule has not been executed.

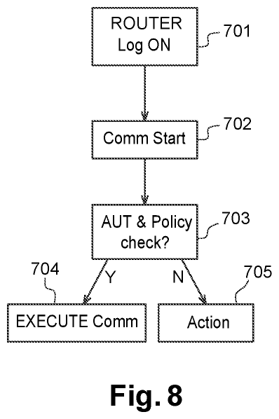

The implementation mode of FIG. 7 may be combined with the implementation modes of FIGS. 5 and 6. This is described in relation with FIG. 8.

FIG. 8 is a block diagram illustrating another implementation mode of a method of secure communication implementing a router and a secure element of a same electronic device. The device is of the type of the device 100 described in relation with FIG. 1, and thus the router and the secure element are, respectively, of the type of router 102 and of secure element 101.

The router described herein comprises a series of rules of the type of the series of rules POL6 described in relation with FIG. 7. The secure element has supplied this series of rules to the router as described in relation with FIG. 7.

At a step 701 (block “Router Log ON”), the router is set to a secure operating mode. This step is identical to the step 404 described in relation with FIG. 5.

At a step 702 (block “Comm Start”), successive to step 701, a communication starts. The communication may be a communication internal to the device or an external communication between the device and another electronic device. In practice, the router starts receiving data with, as an instruction, to transmit them to a module of the device or to another electronic device external to the device.

Further, at step 702, a third-party module is asking for access to all or part of data of the communication.

At a step 703 (block “Aut & Policy Check”), successive to step 702, the data and the communication instruction are submitted to the series of rules stored in the router, and to the authentication method capable of being implemented by the secure mode of the router. According to a first example, the router first implements the series of rules as described in relation with FIG. 7, and then implements the authentication according to one of the variants discussed in relation with FIG. 5 or FIG. 6. According to a second example, the router first implements the authentication according to one of the variants discussed in relation with FIG. 5 or FIG. 6, and then implements the series of rules as described in relation with FIG. 7.

If the third-party module is authorized to get access to data of the communication (output Y of block “Aut & Policy Check”), the next step is a step 704 (block “EXECUTE Comm”), otherwise (output N of block “Aut & Policy check”) the next step is a step 705 (block “Action”).

At step 704, successive to step 703, the router transmit the data to the third-party module without for any other action to be implemented.

At step 705, successive to step 703, the instruction that the router attempts to implement corresponds to the case of one of the rules in the series of rules, and/or the authentication method has not given a positive response. The router then executes the rule and/or forbids the communication.

Various embodiments and variants have been described. Those skilled in the art will understand that certain features of these various embodiments and variants may be combined, and other variants will occur to those skilled in the art.

In particular, different embodiments of execution of the storage of data DATA4 can be planned.

According to a first example, the module storing data DATA4, meaning the router of the secure element, can use a memory with limited storage. If the memory is full then an alert message is sent and the module takes a decision to free storage. According to a variant, the memory can be a circular memory, meaning a memory that, once filled up, erases the most ancient data to free some space. Module can also store only data of a certain type, meaning execute a sorting within data DATA4 in order to store only useful data and avoid double storage of data, such a type of storage is called an aggregation storage.

According to a second example, module storing data DATA4 can decide to store these data in another module of the device, having previously applied a series of rules, if need be.

Finally, the practical implementation of the described embodiments and variations is within the abilities of those skilled in the art based on the functional indications given hereabove.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An electronic device comprising:
at least a first electronic module;
a secure element;
a router configured to transmit first data between the first module and a second module; and
a third-party module different from the first module and the second module,
wherein the electronic device is configured to verify, via an authentication method, whether the third-party module is authorized to access the first data when it requests access to the first data.

2. The device according to claim 1, wherein the secure element or the router is configured to store the first data during implementation of the authentication method.

3. The device according to claim 2, wherein the first data are at least partially visible for the third-party module when stored.

4. The device according to claim 1, wherein the router is configured to implement the authentication method.

5. The device according to claim 1, wherein the secure element is configured to implement the authentication method.

6. The device according to claim 1, wherein the authentication method authenticates the third-party module, and the first module, the second module or a user of the device.

7. The device according to claim 1, wherein the router is configured to request authorization to be in a secure mode.

8. The device according to claim 1, wherein the router comprises a series of rules concerning a security policy of communications of the device.

9. The device according to claim 8, wherein the secure element is configured to transmit the series of rules to the router.

10. The device according to claim 1, wherein the second module is part of the electronic device.

11. A system comprising:
a first electronic device according to claim 1; and
a second electronic device,
wherein the second module is part of the second electronic device different form the first electronic device.

12. A method for communicating first data exchanged between a first module of a first electronic device and a second module to a third-party module of the first electronical device, the third-party module being different than the first module and the second module, wherein the first device comprises a secure element and a router, the method comprising:
transmitting the first data between the first module and the second module;
requesting, by the third-party module, to access the first data; and
verifying, by an authentication method, whether the third-party module is authorized to access to the first data,
wherein the router is adaptable to be set in a secure mode.

13. The method according to claim 12, storing, in the secure element or the router, the first data while performing the authentication method.

14. The method according to claim 13, wherein the first data are at least partially visible for the third-party module when stored.

15. The method according to claim 12, wherein the authentication method is implemented by the router.

16. The method according to claim 12, wherein the authentication method is implemented by the secure element.

17. The method according to claim 12, wherein the authentication method authenticates the third-party module, and the first module, the second module or a user of the first device.

18. The method according to claim 12, wherein the authentication method is implemented by an external server.

19. The method according to claim 12, wherein the authentication method comprises executing secondary rules.

20. The method according to claim 12, further comprising requesting, by the router, an authorization to be in the secure mode, or waiting, by the router, for receiving specific instructions to be in the secure mode.
